(19) United States
(12) Patent Application Publication
(10) Pub. No.: US 2019/0181442 A1
(43) Pub. Date: Jun. 13, 2019

(54) CATHODE ACTIVE MATERIAL FOR LITHIUM ION BATTERY, METHOD FOR PRODUCING THE SAME, LITHIUM ION BATTERY, AND LITHIUM ION BATTERY SYSTEM

(71) Applicants: TOYOTA JIDOSHA KABUSHIKI KAISHA, Toyota-shi (JP); KABUSHIKI KAISHA TOYOTA CHUO KENKYUSHO, Nagakute-shi (JP)

(72) Inventors: Keita NIITANI, Susono-shi (JP); Yoshinari MAKIMURA, Nagakute-shi (JP)

(73) Assignees: TOYOTA JIDOSHA KABUSHIKI KAISHA, Toyota-shi (JP); KABUSHIKI KAISHA TOYOTA CHUO KENKYUSHO, Nagakute-shi (JP)

(21) Appl. No.: 16/207,264

(22) Filed: Dec. 3, 2018

(30) Foreign Application Priority Data
Dec. 11, 2017 (JP) 2017-237011

(51) Int. Cl. H01M 4/485; H01M 10/0525

(52) U.S. Cl. CPC H01M 4/485; H01M 2004/028; H01M 10/0525

(57) ABSTRACT

When spinel-type lithium cobaltate is applied as cathode active material for a lithium ion battery, a spinel-type crystal phase is unstable and is easy to be dislocated to a layered rock-salt structure, which makes it easy to impair battery properties. Thus, manganese is partially substituted for cobalt in spinel-type lithium cobaltate, to achieve stabilization of the spinel-type crystal phase. Specifically, cathode active material is used in a lithium ion battery, the cathode active material including: a composite oxide of lithium and transition metal, wherein the transition metal consists of cobalt as a main constituent, and manganese, and the composite oxide has a spinel-type crystal phase that is formed of lithium, cobalt, manganese, and oxygen.

### FIELD

The present application discloses cathode active material used in a lithium ion battery etc.

### BACKGROUND

As disclosed in Patent Literatures 1 to 3, lithium cobaltate having a layered rock-salt crystal phase is widely used as cathode active material to be used in a lithium ion battery. On the other hand, lithium cobaltate having a spinel-type crystal phase as disclosed in Non Patent Literature 1 has been developed in recent years, and is expected as a new cathode active material for a lithium ion battery.

### CITATION LIST

### Patent Literature

Patent Literature 1: JP 2011-001256 A
Patent Literature 2: JP 2015-032335 A
Patent Literature 3: JP 2013-110064 A

### Non Patent Literature

Non Patent Literature 1: Eungje Lee et al., ACS Appl. Mater. Interfaces 2016, 8, 27720-27729

### SUMMARY

### Technical Problem

According to the new findings of the inventors of the present application, a spinel-type crystal phase that the lithium cobaltate disclosed in Non Patent Literature 1 has is unstable, and is easy to change to a layered rock-salt crystal phase, which is problematic. Therefor, for example, when a lithium ion battery is made using lithium cobaltate having a spinel-type crystal phase as cathode active material, there is a case where battery properties such as capacity, coulombic efficiency, and capacity retention of the battery cannot be obtained.

### Solution to Problem

The present application discloses, as one means for solving the above described problem, cathode active material that is used in a lithium ion battery, the cathode active material comprising: a composite oxide of lithium and transition metal, wherein the transition metal, which is a constituent of the composite oxide, consists of cobalt as a main constituent, and manganese, and the composite oxide has a spinel-type crystal phase that is formed of lithium, cobalt, manganese, and oxygen.

“ . . . comprising: a composite oxide of lithium and transition metal, wherein the transition metal . . . consists of cobalt as a main constituent, and manganese” means, in other words, that the number of moles of cobalt is larger than that of manganese in the composite oxide of lithium, cobalt, and manganese (which hereinafter may be referred to as “lithium cobalt manganate”).

“ . . . has a spinel-type crystal phase” means that at least a diffraction peak derived from the spinel-type crystal phase is confirmed in X-ray diffraction.

Spinel-type lithium cobaltate is different from spinel-type lithium cobalt manganate in lattice constants in a spinel-type crystal phase. That is, whether or not “a spinel-type crystal phase that is formed of lithium, cobalt, manganese, and oxygen” is present in the composite oxide can be confirmed by confirming the composition of the composite oxide by means of X-ray diffraction and elementary analysis, and then confirming lattice constants of a spinel-type crystal phase by means of X-ray diffraction.

In the cathode active material of this disclosure, the composite oxide preferably has composition represented by LiMnₓCo_{y}O_{2±δ}, where 0.1≤x≤≤0.3, 0.7≤y≤0.9, and 0.8≤x+y≤1.2.

For example, the cathode active material of this disclosure can be produced according to the following method: that is, the present application discloses a method for producing the cathode active material of this disclosure, the method comprising: a first step of mixing a lithium source, a cobalt source, and a manganese source, to obtain a mixture; and a second step of heating the mixture, to obtain the composite oxide having the spinel-type crystal phase.

In the method of this disclosure, a heating temperature in the second step is preferably 200° C. to 450° C.

In the method of this disclosure, a heating time in the second step is preferably 1 week or longer.

In the method of this disclosure, a solid state reaction method is preferably used.

A lithium ion battery can be made using the cathode active material of this disclosure. That is, the present application discloses a lithium ion battery comprising: a cathode; an anode; and an electrolyte, wherein the cathode includes the cathode active material of this disclosure.

The cathode active material of this disclosure can function as a high voltage type active material. As a system utilizing this feature, the present application discloses a lithium ion battery system comprising: the lithium ion battery of this disclosure; and a charge and discharge control unit that controls charge and discharge of the lithium ion battery, wherein the charge and discharge control unit makes discharge initial potential, or charge cutoff potential of the cathode of the lithium ion battery no less than 4.2 V (vs. Li⁺/Li).

In the lithium ion battery system of this disclosure, the charge and discharge control unit preferably makes the discharge initial potential, or the charge cutoff potential of the cathode no more than 5.3 V (vs. Li⁺/Li).

“discharge initial potential” refers to potential at which the first discharge is performed after charge of the lithium ion battery is completed. In a case where: after charge of the lithium ion battery is completed, the first discharge is performed and then the discharge is stopped, and thereafter the second or later discharge is performed without any charge; potential in the second or later discharge does not fall under “discharge initial potential”.

In the lithium ion battery system of this disclosure, the composite oxide preferably has composition represented by LiMnₓCo_{y}O_{2±δ}, where 0.2≤x≤0.3, 0.7≤y≤0.8, and 0.8≤x+y≤1.2.

### Advantageous Effects

It is believed that a spinel-type crystal phase of the cathode active material of this disclosure includes manganese in addition to cobalt, which makes the spinel-type crystal phase stable, which leads to suppression of its dislocation to a layered rock-salt crystal phase. Whereby, a lithium ion battery of a large capacity, high coulombic efficiency, or excellent cycle characteristics is obtained.

### BRIEF DESCRIPTION OF DRAWINGS

FIG. 1 is an explanatory schematic view of structure of a lithium ion battery system 10:

FIG. 2 explanatorily shows one example of a control flow in the lithium ion battery system 10:

FIG. 3 shows X-ray diffraction peaks of cathode active materials according to Examples 1 to 3 and Comparative Example 1:

FIG. 4 shows the first charge-discharge curves of lithium ion batteries using the cathode active materials according to Examples 1 and 2, and Comparative Example 1 (4.2 V-2.5 V); and

FIG. 5 shows the first charge-discharge curves of the lithium ion batteries using the cathode active materials according to Examples 1 and 2, and Comparative Example 1 (5.0 V-2.5 V).

### DETAILED DESCRIPTION OF EMBODIMENTS

1. Cathode Active Material

The cathode active material of this disclosure is cathode active material that is used in a lithium ion battery, the cathode active material comprising: a composite oxide of lithium and transition metal, wherein the transition metal, which is a constituent of the composite oxide, consists of cobalt as a main constituent, and manganese, and the composite oxide has a spinel-type crystal phase that is formed of lithium, cobalt, manganese, and oxygen.

The composite oxide included in the cathode active material of this disclosure is a composite oxide of lithium and transition metal. In this composite oxide, the transition metal consists of cobalt and manganese; that is, any transition metal other than them is not included. The main constituent of the transition metal is cobalt; that is, cobalt is more than manganese in terms of mole. In this point, the composite oxide included in the cathode active material of this disclosure can be said to be a composite oxide where manganese is partially substituted for cobalt in lithium cobaltate as well.

The composite oxide included in the cathode active material of this disclosure has a spinel-type crystal phase. For example, diffraction peaks derived from a spinel-type crystal phase are preferably confirmed at positions where 2θ=19.8±0.4°, 37.3±0.4°, 39.0±0.4°, 45.3±0.4°, 49.7±0.4°, 60.1±0.4°, 66.1±0.4° and 69.5±0.4° in X-ray diffraction measurement using CuKα as a source which the composite oxide is subjected to.

In the composite oxide included in the cathode active material of this disclosure, the spinel-type crystal phase is constituted of lithium, cobalt, manganese, and oxygen. That is, this spinel-type crystal phase is formed of lithium cobalt manganate; and in other words, can be said to be a phase where manganese is partially substituted for cobalt in spinel-type lithium cobaltate as well. In the composite oxide included in the cathode active material of this disclosure, the a-axis lattice constant of the spinel-type crystal phase is preferably no less than 7.992 Å. The change in expansion/contraction of the cathode active material of this disclosure according to charge/discharge is preferably no more than 0.6%.

The composite oxide included in the cathode active material of this disclosure preferably has the composition represented by LiMnₓCo_{y}O_{2±δ} (0.1≤x≤0.3, 0.7≤y≤0.9, 0.8≤x+y≤1.2). According to the findings of the inventors of the present application, the above described spinel-type lithium cobalt manganate is easy to be obtained when a composite oxide has that composition, which may largely contribute to increase of capacity, improvement of coulombic efficiency, or improvement of cycle characteristics.

In view of increasing capacity, in the composition formula, more preferably 0.1≤x≤0.2 and 0.8≤y≤0.9. For example, 0.8≤x+y≤1.2 may be satisfied. According to the findings of the inventors of the present application, when 0.1≤x≤0.2 and 0.8≤y≤0.9, spinel-type crystal phases in a composite oxide increase, and the 3.5 V plateau increases. On the other hand, in view of improving coulombic efficiency and cycle characteristics, in the composition formula, more preferably 0.2≤x≤0.3 and 0.7≤y≤0.8. For example, 0.8≤x+y≤1.2 may be satisfied.

In the composite oxide, the molar ratio of the transition metal (the total of Co and Mn) to Li is preferably 1 (x+y=1). However, even if Li is a little excessive, or a little short compared to the transition metal, spinel-type lithium cobalt manganate can be obtained, and the problem can be solved. In this point, as represented by the composition formula, the molar ratio of the transition metal to Li is preferably 0.8 to 1.2 (0.8≤x+y≤1.2). The lower limit is more preferably no less than 0.9, and further preferably no less than 0.95, and the upper limit is more preferably no more than 1.1, and further preferably no more than 1.05. In the stoichiometric ratio as a spinel-type crystal phase in the composite oxide, the molar ratio of O to Li (O/Li) is 2. However, the crystalline structure of the spinel-type crystal phase itself is kept, and a desired effect can be brought about even if oxygen is excessive, or even if the spinel-type crystal phase is partially deficient in oxygen, compared to the stoichiometric ratio as a spinel-type crystal phase. In this point, for example, the molar ratio of O to Li (O/Li) is preferably 1.6 to 2.2. Or, in the composition formula, δ is preferably no more than 0.2.

The composite oxide included in the cathode active material of this disclosure has the above described specific spinel-type crystal phase. In contrast, the composite oxide may include a crystal phase other than this spinel-type crystal phase in addition to the spinel-type crystal phase as long as the problem can be solved. For example, there is a case where a layered rock-salt crystal phase is difficult to be completely removed in the composite oxide formed of lithium cobalt manganate. Even in such a case, a desired effect can be brought about by the presence of the spinel-type crystal phase. In this point, the composite oxide may include a layered rock-salt crystal phase in addition to the spinel-type crystal phase. Preferably, diffraction peaks only derived from the spinel-type crystal phase are confirmed, or diffraction peaks only derived from two crystal phases of the spinel-type crystal phase and a layered rock-salt crystal phase are confirmed in X-ray diffraction measurement that the composite oxide is subjected to.

The cathode active material of this disclosure essentially includes the composite oxide. On the other hand, the cathode active material of this disclosure may include any components other than the composite oxide in addition to the composite oxide as long as the problem can be solved. For example, a composite oxide other than the composite oxide may be mixed to be used.

The shape and size of the cathode active material of this disclosure are not specifically limited as long as the shape and size may be applied to a cathode of a lithium ion battery. Preferably, the cathode active material is in the form of a particle.

As described above, it is believed that including manganese in the spinel-type crystal phase of the cathode active material of this disclosure in addition to cobalt makes the spinel-type crystal phase stable, which suppresses its dislocation to a layered rock-salt crystal phase. Whereby, a battery of a high capacity, high coulombic efficiency, or excellent cycle characteristics is obtained.

2. Method for Producing Cathode Active Material

For example, the cathode active material of this disclosure can be produced via a first step of mixing a lithium source, a cobalt source, and a manganese source, to obtain a mixture; and a second step of heating the mixture, to obtain the composite oxide having the spinel-type crystal phase.

2.1. First Step

In the first step, a lithium source, a cobalt source and a manganese source are mixed to obtain a mixture. Examples of the lithium source include lithium compounds and lithium metal. Examples of lithium compounds include lithium carbonate, lithium oxide, and lithium hydroxide. Among them, lithium carbonate is preferable. Examples of the cobalt source include cobalt compounds and metal cobalt. Examples of cobalt compounds include cobalt carbonate, cobalt oxide, and cobalt hydroxide. Among them, cobalt oxide is preferable, and Co₃O₄ is more preferable. Examples of the manganese source include manganese compounds and metal manganese. Examples of manganese compounds include manganese carbonate, manganese oxide, and manganese hydroxide. Among them, manganese carbonate is preferable.

The proportion (molar ratio) of lithium, cobalt, and manganese in the mixture has only to be such that the cathode active material of this disclosure can be produced. That is, cobalt is more than manganese in terms of mole. Preferably, the proportion of lithium, manganese, and cobalt contained in the mixture which is represented by the molar ratio is, lithium:manganese:cobalt=1:0.1 to 0.3:0.7 to 0.9.

The mixing way of the lithium source, the cobalt source, and the manganese source is not specifically limited. Any way such as dry mixing that does not use solvent, and wet mixing that uses solvent can be employed. In the first step, one may dissolve the raw materials to make the mixture formed of solution, or mix the granular materials with each other to make the mixture of the granular materials. Mixing may be manually carried out using a mortar or the like, or may be mechanically carried out using a ball mill or the like.

2.2. Second Step

In the second step, the mixture obtained in the first step is heated to obtain the composite oxide having the spinel-type crystal phase. Normally, a layered rock-salt crystal phase is thermally more stable than a spinel-type crystal phase. Thus, if the heating temperature in the second step is too high, layered rock-salt crystal phases are formed more than spinel-type crystal phases. That is, when a desired spinel-type crystal phase is obtained in the mixture, preferably, the heating temperature in the second step is low and the heating time is long. Specifically, according to the findings of the inventors of the present application, the heating temperature in the second step is 200° C. to 450° C., which makes it easy to obtain a desired spinel-type crystal phase. The lower limit of the heating temperature is more preferably no less than 250° C., and further preferably no less than 280° C., and the upper limit thereof is more preferably no more than 430° C., and further preferably no more than 410° C. The heating time in the second step may be adjusted according to the heating temperature. As describes above, in the second step, the mixture is preferably heated at a low temperature for a long time. For example, heating for one week or longer can improve the crystallinity of the spinel-type crystal phase. The heating atmosphere in the second step has only to be such that the composite oxide can be formed. For example, the heating atmosphere may be the atmosphere, or an oxygen atmosphere.

In the producing method of this disclosure, a solid state reaction method is preferably used. According to the findings of the inventors of the present application, mixing a lithium source etc. as granular material to obtain lithium cobalt manganate by a solid state reaction method is easier to suppress formation of a layered rock-salt crystal phase and at the same time to form a spinel-type crystal phase than dissolving a lithium source etc. in solution to obtain lithium cobalt manganate by the sol-gel process or the like.

3. Lithium Ion Battery

The technique of this disclosure also has an aspect as a lithium ion battery. That is, the lithium ion battery of this disclosure has the feature of including a cathode, an anode, and an electrolyte, and the cathode includes the cathode active material of this disclosure.

3.1. Cathode

The cathode may have the same structure as conventional one except that the cathode active material of this disclosure is included. For example, the cathode includes a cathode current collector, and a cathode active material layer including the cathode active material of this disclosure. For example, the cathode current collector may be made of any metal. The cathode active material layer may optionally include binder and a conductive additive in addition to the cathode active material. The rate of expansion/contraction of the cathode active material of this disclosure according to charge/discharge is low, which is especially advantageous in a solid battery in which interfacial contact between particles is important. In this point, when a solid battery is employed as the lithium ion battery, the cathode active material layer preferably includes a solid electrolyte. As the solid electrolyte, an inorganic solid electrolyte such as an oxide solid electrolyte and a sulfide solid electrolyte is preferable, and a sulfide solid electrolyte is more preferable. When a sulfide solid electrolyte is included in the cathode, in view of suppressing formation of a high resistance layer over the interface between the cathode active material and the sulfide solid electrolyte etc., a coating layer such as a layer of lithium niobate may be provided over the surface of the cathode active material. The structures other than the cathode active material are obvious from the technical common sense, and thus more detailed description thereof is omitted.

3.2. Anode

One known as an anode for a lithium ion battery can be employed as the anode. For example, the anode includes an anode current collector, and an anode active material layer including anode active material. For example, the anode current collector may be made of any metal. A material whose charge-discharge potential of lithium ions is baser than the cathode active material of this disclosure may be employed as the anode active material. The anode active material layer may optionally include binder and a conductive additive in addition to the anode active material. When a solid battery is employed as the lithium ion battery, the anode active material layer preferably includes a solid electrolyte as described above. The structure of the anode is obvious from the technical common sense, and thus more detailed description thereof is omitted.

3.3. Electrolyte

The electrolyte is for conducting lithium ions between the cathode and the anode. Any of electrolyte solution and solid electrolytes may be employed as the electrolyte. When electrolyte solution is employed, one may arrange a separator between the cathode and the anode, and immerse the separator in the electrolyte solution. On the other hand, when a solid electrolyte is employed, a solid electrolyte layer may be arranged between the cathode and the anode. The solid electrolyte layer includes a solid electrolyte as described above, and optionally binder. The components of the electrolyte are obvious from the technical common sense, and thus more detailed description thereof is omitted.

3.4. Other Components

The lithium ion battery has only to include the cathode, the anode and the electrolyte. Other than them, terminals, a battery case, etc. are included if necessary. The structures thereof are obvious from the technical common sense, and thus more detailed description thereof is omitted.

As described above, the lithium ion battery of this disclosure employs the cathode active material of this disclosure in the cathode, and has excellent stability of the spinel crystal phase of the cathode active material. Therefore, the battery has a high capacity, high coulombic efficiency, or excellent cycle characteristics. In view of coulombic efficiency and cycle characteristics, the lithium ion battery of this disclosure is preferably used as not only a primary battery but also a secondary battery.

4. Lithium Ion Battery System

The cathode active material of this disclosure is superior to conventional cathode active material in stability of the spinel-type crystal phase, and for example, can function as a high voltage type active material. In this point, when the lithium ion battery including the cathode active material of this disclosure is charged/discharged, a charge and discharge control unit preferably controls charge and discharge of the lithium ion battery, to make discharge initial voltage or charge cut-off voltage high.

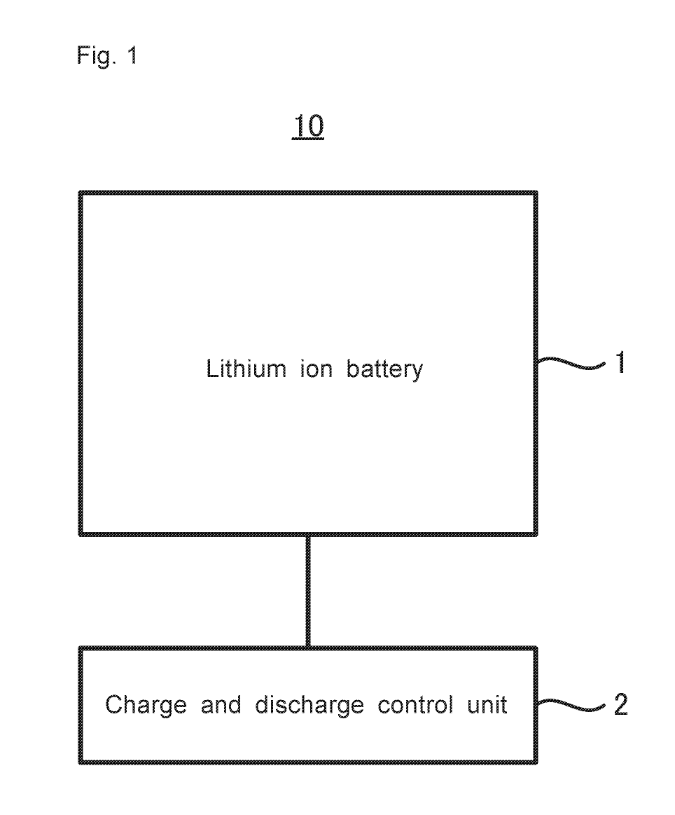

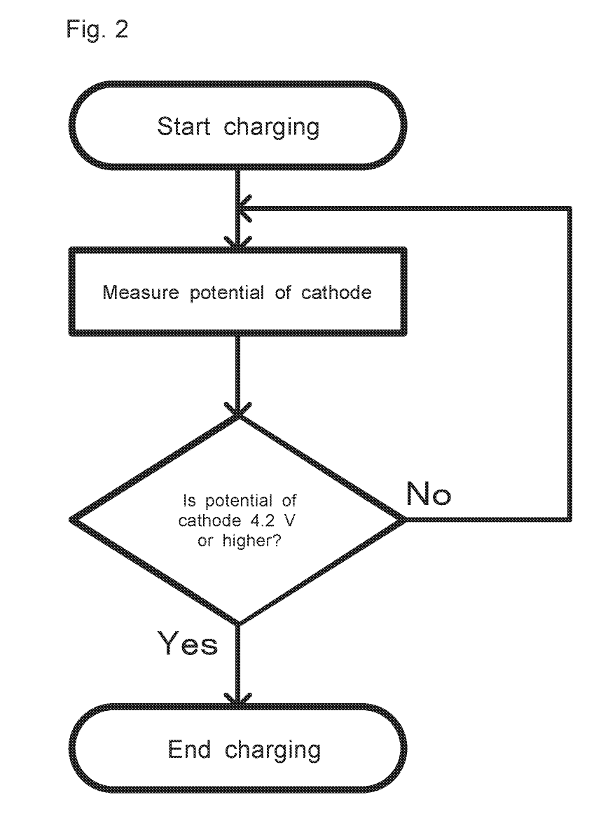

FIG. 1 schematically shows an example of the structure of a lithium ion battery system 10. FIG. 2 shows an example of the control flow in the lithium ion battery system 10. As shown in FIGS. 1 and 2, the lithium ion battery system 10 has the feature of including a lithium ion battery 1 that includes the cathode active material of this disclosure, and a charge and discharge control unit 2 that controls charge and discharge of the lithium ion battery 1, wherein the charge and discharge control unit 2 makes discharge initial potential, or charge cutoff potential of the cathode of the lithium ion battery 1 no less than 4.2 V (vs. Li⁺/Li).

According to the findings of the inventors of the present application, a curve derived from a layered rock-salt crystal phase appears in a discharge curve of conventional spinel-type lithium cobaltate after 4.2 V charge. That is, it is believed that spinel-type crystal phases are partially dislocated to layered rock-salt crystal phases. In contrast, manganese is partially substituted for cobalt in spinel-type lithium cobaltate in the cathode active material of this disclosure, to achieve stabilization of the spinel-type crystal phase. Thus, even if the discharge initial potential, or charge cut-off potential of the cathode of the lithium ion battery 1 is no less than 4.2 V (vs. Li⁺/Li), the cathode active material keeps the spinel-type crystal phase, and charge and discharge can be properly performed. For example, no less than 4.2 V (vs. Li⁺/Li) of the discharge initial potential or charge cut-off potential makes it possible to insert/eliminate lithium using a plateau in the vicinity of 3.6 V (vs. Li⁺/Li) or a plateau in the vicinity of 4.0 V (vs. Li⁺/Li) in the spinel-type active material as well.

According to the findings of the inventors of the present application, in conventional spinel-type lithium cobaltate, most of spinel-type crystal phases might be dislocated to layered rock-salt crystal phases at approximately 4.5 V. On the other hand, the spinel-type crystal phase included in the cathode active material of this disclosure can bear high potential of no less than 4.5 V owning to stabilization effect of manganese. According to the findings of the inventors of the present application, the cathode active material of this disclosure makes it possible to insert/eliminate lithium at a site different from the above described plateaus at a potential of no less than 4.5 V. In this point, in the lithium ion battery system of this disclosure, the discharge initial potential or charge cut-off potential of the cathode of the lithium ion battery 1 is preferably no less than 4.5 V (vs. Li⁺/Li). Whereby, a larger capacity can be obtained.

The charge and discharge control unit 2 has only to be able to control charge and discharge of the lithium ion battery 1 as descried above. For example, as shown in FIG. 2, when the lithium ion battery 1 is charged using a power source, one may measure the potential of the cathode of the lithium ion battery 1 successively, continue to charge the battery if the measured potential of the cathode is lower than 4.2 V. and stop the supply of electricity from the power source, to stop charging the battery if the measured potential of the cathode is no less than 4.2 V.

This also applies to the discharge initial potential. That is, in a case where the first discharge is performed after the lithium ion battery 1 is charged, one may measure the potential of the cathode before the first discharge: if the measured potential of the cathode is lower than 4.2 V, the lithium ion battery 1 is not discharged but charged: if the potential of the cathode is no less than 4.2 V as a result of charging the lithium ion battery 1, one may perform the first discharge.

When the charge and discharge control unit 2 controls charge and discharge of the lithium ion battery 1, the upper limit of the discharge initial potential or charge cut-off potential of the lithium ion battery 1 is not specifically limited. Too high potential thereof results in small effect. Rather, deterioration, decomposition, etc. of members of the battery are concerned. In this point, the charge and discharge control unit 2 preferably makes the discharge initial potential or charge cut-off potential of the cathode of the lithium ion battery 1 no more than 5.3 V (vs. Li⁺/Li), which is more preferably no more than 5.1 V (vs. Li⁺/Li), and further preferably no more than 5.0 V (vs. Li⁺/Li).

As described above, in view of further increasing the capacity in the lithium ion battery system, the composite oxide more preferably has the composition represented by LiMnₓCo_{y}O_{2±δ} (0.1≤x≤0.2, 0.8≤y≤0.9, 0.8≤x+y≤1.2). In contrast, in view of improving coulombic efficiency and cycle characteristics, the composite oxide preferably has the composition represented by LiMnₓCo_{y}O_{2±δ} (0.2≤x≤0.3, 0.75≤y≤0.8, 0.8≤x+y≤1.2).

### EXAMPLES

1. Synthesizing Cathode Active Material (Spinel-Type Composite Oxide)

### Example 1

Lithium carbonate (Li₂CO₃) was used as a lithium source, cobalt oxide (Co₃O₄) was used as a cobalt source, and manganese carbonate (MnCO₃) was used as a manganese source. They were weighed so that the molar ratio thereof was, Li:Co:Mn=1:0.9:0.1, and the granular materials were mixed with each other until they were uniform. The obtained mixture was calcined under the atmosphere at 400° C. for 1 week or longer, to obtain a cathode active material (LiMn_{0.1}Co_{0.9}O_{2±δ}) according to Example 1.

### Example 2

A cathode active material (LiMn_{0.2}Co_{0.8}O_{2±δ}) according to Example 2 was obtained in the same manner as Example 1 except that the composition ratio of the raw materials in the mixture was, Li:Co:Mn=1:0.8:0.2.

### Example 3

A cathode active material (LiMn_{0.3}Co_{0.7}O_{2±δ}) according to Example 3 was obtained in the same manner as Example 1 except that the composition ratio of the raw materials in the mixture was, Li:Co:Mn=1:0.7:0.3.

### Comparative Example 1

A cathode active material (LiCoO_{2±δ}) according to Comparative Example 1 was obtained in the same manner as Example 1 except that the composition ratio of the raw materials in the mixture was, Li:Co:Mn=1:1:0.

2. Confirmation of Crystal Phase

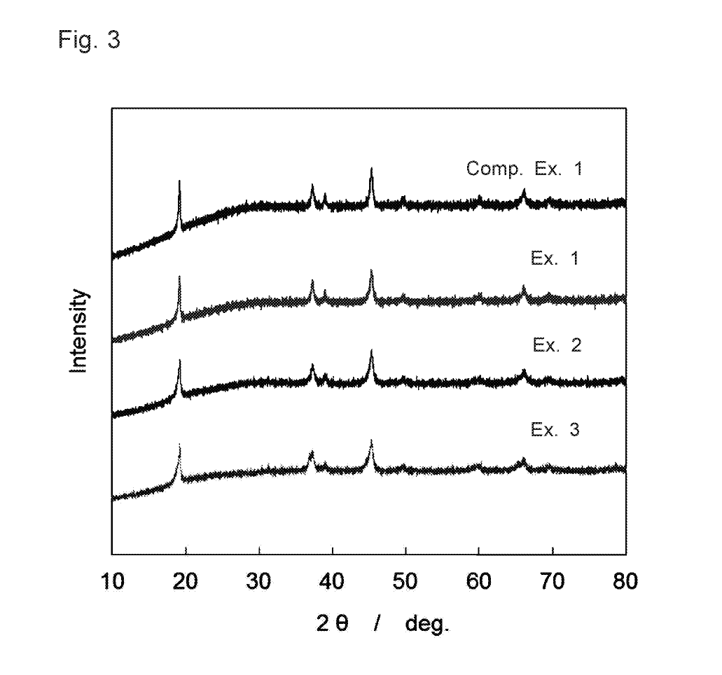

The cathode active materials of Examples 1 to 3 and Comparative Example 1 were subjected to X-ray diffraction measurement using CuKα as a source, to confirm diffraction peaks. FIG. 3 shows the results of the X-ray diffraction measurement. As is apparent from the results shown in FIG. 3, diffraction peaks derived from a spinel-type crystal phase were able to be confirmed in all the cathode active materials of Examples 1 to 3, and Comparative Example 1. It was also found that from the diffraction peak positions, lattice constants of a spinel-type crystal phase in Example 1 were smaller than those in Comparative Example 1. Specifically, while the a-axis lattice constant of the spinel-type crystal phase according to Comparative Example 1 was 7.987 Å, the lattice constant of the spinel-type crystal phase according to Example 1 was 7.992 Å. There was a tendency that as Mn increased, lattice constants became large.

3. Making Electrode

An obtained cathode active material, a conductive additive (acetylene black), and binder (PTFE) were weighed so that their mass ratio was, cathode active material:conductive additive:binder=80:10:10, and the granular materials were mixed with each other until they were uniform. The obtained cathode mixture was pressurized to be flat, and punched out to have 8 mm in diameter, to obtain a pellet electrode (10 to 20 mg).

4. Making Lithium Ion Battery

The pellet electrode was used as a cathode, a lithium foil was used as an anode, and a F-substituted carbonate-based electrolyte solution was used as electrolyte solution. A separator was arranged between the pellet electrode and the lithium foil, to be sealed into a coin-type battery together with the electrolyte solution, to obtain a lithium ion battery for evaluation.

5. Charge-Discharge Testing

Charge-discharge testing was carried out under the following conditions to confirm: (1) first discharge capacity after 4.2 V charge; (2) first discharge capacity after 5.0 V charge; (3) coulombic efficiency at the first charge-discharge cycle after 4.2 V charge; and (4) discharge capacity retention at the third charge-discharge cycle after 4.2 V charge ((discharge capacity at the third cycle/discharge capacity at the first cycle)×100).

(Charge-Discharge Conditions)

CC charge: a current value is 0.1 to 0.2 mA; an end condition is 5.0 V or 4.2 V

CC discharge: a current value is 0.1 to 0.2 mA; an end condition is 2.5 V

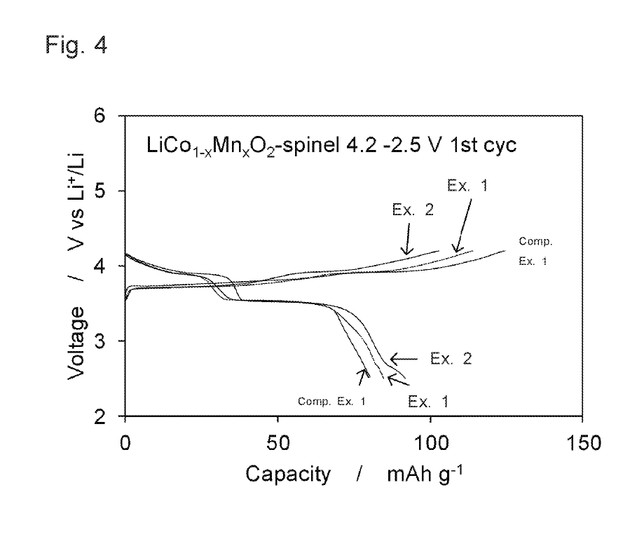

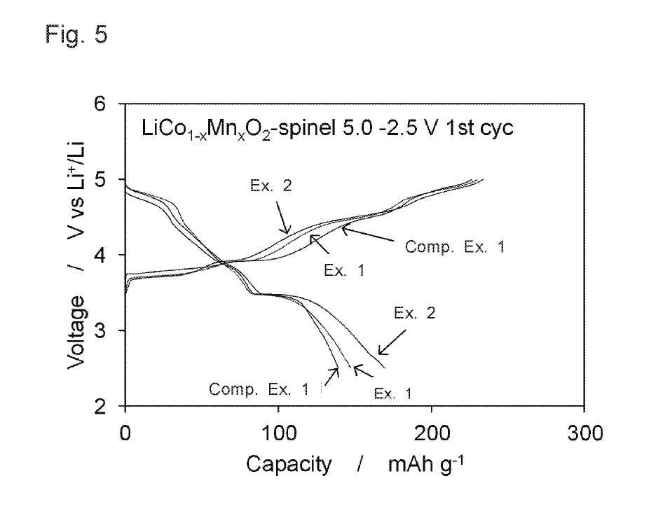

The results are shown in the following Table 1. For reference, FIGS. 4 and 5 show charge-discharge curves of Examples 1 and 2 and Comparative Example 1.

TABLE 1

| | Discharge | Discharge | | 3rd cycle |
|---|---|---|---|---|
| | capacity after | capacity after | Coulombic | capacity |
| | 4.2 V charge | 5.0 V charge | efficiency | retention |
| | (mAh/g) | (mAh/g) | (%) | (%) |
| Comp. Ex. 1 | 80 | 139 | 64 | 94 |
| Ex. 1 | 85 | 147 | 75 | 93 |
| Ex. 2 | 92 | 169 | 89 | 101 |
| Ex. 3 | 73 | 144 | 90 | 101 |

As is apparent from the results shown in Table 1 and FIGS. 4 and 5, Example 1 was superior to Comparative Example 1 in discharge capacity after 4.2 V charge, discharge capacity after 5.0 V charge, and coulombic efficiency, and had cycle characteristics equivalent to Comparative Example 1. Example 2 was superior to Comparative Example 1 in all of discharge capacity after 4.2 V charge, discharge capacity after 5.0 V charge, coulombic efficiency, and cycle characteristics. Further, Example 3 had superior properties to Comparative Example 1 in discharge capacity after 5.0 V charge, coulombic efficiency, and cycle characteristics while being a little inferior to Comparative Example 1 in discharge capacity after 4.2 V charge.

From above descried results, it was found that the performance of active material where manganese is partially substituted for cobalt in spinel-type lithium cobaltate can be superior to that of spinel-type lithium cobaltate, as cathode active material of a lithium ion battery. It is believed that partially substituting manganese for cobalt in spinel-type lithium cobaltate makes a spinel-type crystal phase stable, which makes it possible to suppress its dislocation to a layered rock-salt crystal phase etc.

From these results, in view of further increasing capacity, it can be said that the composite oxide more preferably has the composition represented by LiMnₓCo_{y}O_{2±δ} (0.1≤x≤0.2, 0.8≤y≤0.9, 0.8≤x+y≤1.2). On the other hand, in view of improving coulombic efficiency and cycle characteristics, it can be said that the composite oxide more preferably has the composition represented by LiMnₓCo_{y}O_{2±δ} (0.2≤x≤0.3, 0.7≤y≤0.8, 0.8≤x+y≤1.2).

In the Examples, Examples 1 to 3 where the content of manganese was 0.1 to 0.3 were given. The cathode active material of this disclosure is not restricted to them. As described above, the technique of this disclosure achieves stabilization of a spinel-type crystal phase by partially substituting manganese for cobalt in spinel-type lithium cobaltate. It is believed that even if the content of manganese is less than 0.1, or is more than 0.3, a desired effect can be brought about. Too large a content of manganese might impair battery properties. Thus, preferably the number of moles of cobalt is larger than that of manganese in lithium cobalt manganate (content of manganese is less than 0.5).

In the Examples, the molar ratio of lithium and transition metal (the total of cobalt and manganese) was adjusted to be 1. The molar ratio of transition metal to lithium is not limited to this as long as the composite oxide having a spinel-type crystal phase can be obtained.

### INDUSTRIAL APPLICABILITY

A lithium ion battery using the cathode active material according to this disclosure can be used in a wide range of power sources such as a small-sized power source for portable devices and an onboard large-sized power source.

### REFERENCE SIGNS LIST

1 lithium ion battery
2 charge and discharge control unit
10 lithium ion battery system

What is claimed is:

1. Cathode active material that is used in a lithium ion battery, the cathode active material comprising:
a composite oxide of lithium and transition metal,
wherein the transition metal, which is a constituent of the composite oxide, consists of cobalt as a main constituent, and manganese, and
the composite oxide has a spinel-type crystal phase that is formed of lithium, cobalt, manganese, and oxygen.

2. The cathode active material according to claim 1, wherein
the composite oxide has composition represented by LiMnₓCo_{y}O_{2±δ}, where 0.1≤x≤0.3, 0.7≤y≤0.9, and 0.8≤x+y≤1.2.

3. A method for producing the cathode active material according to claim 1, the method comprising:
a first step of mixing a lithium source, a cobalt source, and a manganese source, to obtain a mixture; and
a second step of heating the mixture, to obtain the composite oxide having the spinel-type crystal phase.

4. The method according to claim 3, wherein a heating temperature in the second step is 200° C. to 450° C.

5. The method according to claim 4, wherein a heating time in the second step is 1 week or longer.

6. The method according to claim 3, wherein a solid state reaction method is used.

7. A lithium ion battery comprising:
a cathode;
an anode; and
an electrolyte,
wherein the cathode includes the cathode active material according to claim 1.

8. A lithium ion battery system comprising:
the lithium ion battery according to claim 7; and
a charge and discharge control unit that controls charge and discharge of the lithium ion battery,
wherein the charge and discharge control unit makes discharge initial potential, or charge cutoff potential of the cathode of the lithium ion battery no less than 4.2 V (vs. Li⁺/Li).

9. The lithium ion battery system according to claim 8, wherein
the charge and discharge control unit makes the discharge initial potential, or the charge cutoff potential of the cathode of the lithium ion battery no more than 5.3 V (vs. Li⁺/Li).

10. The lithium ion battery system according to claim 8, wherein
the composite oxide has composition represented by LiMnₓCo_{y}O_{2±δ}, where 0.2≤x≤0.3, 0.7≤y≤0.8, and 0.8≤x+y≤1.2.
